(19) United States
(12) Patent Application Publication
(10) Pub. No.: US 2002/0069066 A1
(43) Pub. Date: Jun. 6, 2002

(54) Locality-dependent presentation

(76) Inventors: Simon Edwin Crouch, Bristol (GB); Paul St. John Brittan, Claverham (GB); Stephen John Hinde, Bristol (GB); Robert Francis Squibbs, Bristol (GB)

Correspondence Address: LOWE HAUPTMAN GILMAN & BERNER, LLP (22429), Suite 310, 1700 Diagonal Road, Alexandria, VA, 22314, US

(21) Appl. No.: 09/994,913

(22) Filed: Nov. 27, 2001

(30) Foreign Application Priority Data
Nov. 29, 2000 (GB) 0029022.1

(51) Int. Cl. G10L 11/00

(52) U.S. Cl. 704/270.1

(57) ABSTRACT

Content received from a content server is presented to a user with at least one attribute of the presentation, other than the content itself and language in which it is presented, set in dependence on the user's current locality or a locality indicated in locality data received with the content. Thus, where the content is presented by voice, the accent of the voice is set to reflect a regional accent appropriate to the controlling locality. The content is, for example, provided in the form of content pages intended for use with a style sheet, the style sheet being selected according to the controlling locality.

### FIELD OF THE INVENTION

The present invention relates to varying the presentation of content in dependence on the location of the consumer of the content; in particular, but not exclusively, the present invention relates to varying how a voice service is presented to a user depending on locality.

### BACKGROUND OF THE INVENTION

In recent years there has been an explosion in the number of services available over the World Wide Web on the public internet (generally referred to as the “web”), the web being composed of a myriad of pages linked together by hyperlinks and delivered by servers on request using the HTTP protocol. Each page comprises content marked up with tags to enable the receiving application (typically a GUI browser) to render the page content in the manner intended by the page author; the markup language used for standard web pages is HTML (HyperText Markup Language).

However, today far more people have access to a telephone than have access to a computer with an Internet connection. Sales of cellphones are outstripping PC sales so that many people have already or soon will have a phone within reach where ever they go. As a result, there is increasing interest in being able to access web-based services from phones. ‘Voice Browsers’ offer the promise of allowing everyone to access web-based services from any phone, making it practical to access the Web any time and any where, whether at home, on the move, or at work.

Voice browsers allow people to access the Web using speech synthesis, pre-recorded audio, and speech recognition. FIG. 1 of the accompanying drawings illustrates the general role played by a voice browser. As can be seen, a voice browser is interposed between a user 2 and a voice page server 4. This server 4 holds voice service pages (text pages) that are marked-up with tags of a voice-related markup language (or languages). When a page is requested by the user 2, it is interpreted at a top level (dialog level) by a dialog manager 7 of the voice browser 3 and output intended for the user is passed in text form to a Text-To-Speech (TTS) converter 6 which provides appropriate voice output to the user. User voice input is converted to text by speech recognition module 5 of the voice browser 3 and the dialog manager 7 determines what action is to be taken according to the received input and the directions in the original page. The voice input/output interface can be supplemented by keypads and small displays.

In general terms, therefore, a voice browser can be considered as a largely software device which interprets a voice markup language and generate a dialog with voice output, and possibly other output modalities, and/or voice input, and possibly other modalities (this definition derives from a working draft, dated September 2000, of the Voice browser Working Group of the World Wide Web Consortium).

Voice browsers may also be used together with graphical displays, keyboards, and pointing devices (e.g. a mouse) in order to produce a rich “multimodal voice browser”. Voice interfaces and the keyboard, pointing device and display maybe used as alternate interfaces to the same service or could be seen as being used together to give a rich interface using all these modes combined.

Some examples of devices that allow multimodal interactions could be multimedia PC, or a communication appliance incorporating a display, keyboard, microphone and speaker/headset, an in car Voice Browser might have display and speech interfaces that could work together, or a Kiosk.

Some services may use all the modes together to provide an enhanced user experience, for example, a user could touch a street map displayed on a touch sensitive display and say “Tell me how I get here?”. Some services might offer alternate interfaces allowing the user flexibility when doing different activities. For example while driving speech could be used to access services, but a passenger might used the keyboard.

FIG. 2 of the accompanying drawings shows in greater detail the components of an example voice browser for handling voice pages 15 marked up with tags related to four different voice markup languages, namely:

tags of a dialog markup language that serves to specify voice dialog behaviour;

tags of a multimodal markup language that extends the dialog markup language to support other input modes (keyboard, mouse, etc.) and output modes (large and small screens);

tags of a speech grammar markup language that serve to specify the grammar of user input; and

tags of a speech synthesis markup language that serve to specify voice characteristics, types of sentences, word emphasis, etc.

When a page 15 is loaded into the voice browser, dialog manager 7 determines from the dialog tags and multimodal tags what actions are to be taken (the dialog manager being programmed to understand both the dialog and multimodal languages 19). These actions may include auxiliary functions 18 (available at any time during page processing) accessible through APIs and including such things as database lookups, user identity and validation, telephone call control etc. When speech output to the user is called for, the semantics of the output is passed, with any associated speech synthesis tags, to output channel 12 where a language generator 23 produces the final text to be rendered into speech by text-to-speech converter 6 and output to speaker 17. In the simplest case, the text to be rendered into speech is fully specified in the voice page 15 and the language generator 23 is not required for generating the final output text; however, in more complex cases, only semantic elements are passed, embedded in tags of a natural language semantics markup language (not depicted in FIG. 2) that is understood by the language generator. The TTS converter 6 takes account of the speech synthesis tags when effecting text to speech conversion for which purpose it is cognisant of the speech synthesis markup language 25.

User voice input is received by microphone 16 and supplied to an input channel of the voice browser. Speech recogniser 5 generates text which is fed to a language understanding module 21 to produce semantics of the input for passing to the dialog manager 7. The speech recogniser 5 and language understanding module 21 work according to specific lexicon and grammar markup language 22 and, of course, take account of any grammar tags related to the current input that appear in page 15. The semantic output to the dialog manager 7 may simply be a permitted input word or may be more complex and include embedded tags of a natural language semantics markup language. The dialog manager 7 determines what action to take next (including, for example, fetching another page) based on the received user input and the dialog tags in the current page 15.

Any multimodal tags in the voice page 15 are used to control and interpret multimodal input/output. Such input/output is enabled by an appropriate recogniser 27 in the input channel 11 and an appropriate output constructor 28 in the output channel 12.

Whatever its precise form, the voice browser can be located at any point between the user and the voice page server. FIGS. 3 to 5 illustrate three possibilities in the case where the voice browser functionality is kept all together; many other possibilities exist when the functional components of the voice browser are separated and located in different logical/physical locations.

In FIG. 3, the voice browser 3 is depicted as incorporated into an end-user system 8 (such as a PC or mobile entity) associated with user 2. In this case, the voice page server 4 is connected to the voice browser 3 by any suitable data-capable bearer service extending across one or more networks 9 that serve to provide connectivity between server 4 and end-user system 8. The data-capable bearer service is only required to carry text-based pages and therefore does not require a high bandwidth.

FIG. 4 shows the voice browser 3 as co-located with the voice page server 4. In this case, voice input/output is passed across a voice network 9 between the end-user system 8 and the voice browser 3 at the voice page server site. The fact that the voice service is embodied as voice pages interpreted by a voice browser is not apparent to the user or network and the service could be implemented in other ways without the user or network being aware.

In FIG. 5, the voice browser 3 is located in the network infrastructure between the end-user system 8 and the voice page server 4, voice input and output passing between the end-user system and voice browser over one network leg, and voice-page text data passing between the voice page server 4 and voice browser 3 over another network leg. This arrangement has certain advantages; in particular, by locating expensive resources (speech recognition, TTS converter) in the network, they can be used for many different users with user profiles being used to customise the voice-browser service provided to each user.

A more specific and detailed example will now be given to illustrate how voice browser functionality can be differently located between the user and server. More particularly, FIG. 6 illustrates the provision of voice services to a mobile entity 40 which can communicate over a mobile communication infrastructure with voice-based service systems 4, 61. In this example, the mobile entity 40 communicates, using radio subsystem 42 and a phone subsystem 43, with the fixed infrastructure of a GSM PLMN (Public Land Mobile Network) 30 to provide basic voice telephony services. In addition, the mobile entity 40 includes a data-handling subsystem 45 interworking, via data interface 44, with the radio subsystem 42 for the transmission and reception of data over a data-capable bearer service provided by the PLMN; the data-capable bearer service enables the mobile entity 40 to access the public Internet 60 (or other data network). The data handling subsystem 45 supports an operating environment 46 in which applications run, the operating environment including an appropriate communications stack.

Considering the FIG. 6 arrangement in more detail, the fixed infrastructure 30 of the GSM PLMN comprises one or more Base Station Subsystems (BSS) 31 and aNetwork and Switching Subsystem NSS 32. Each BSS 31 comprises a Base Station Controller (BSC) 34 controlling multiple Base Transceiver Stations (BTS) 33 each associated with a respective “cell” of the radio network. When active, the radio subsystem 42 of the mobile entity 20 communicates via a radio link with the BTS 33 of the cell in which the mobile entity is currently located. As regards the NSS 32, this comprises one or more Mobile Switching Centers (MSC) 35 together with other elements such as Visitor Location Registers 52 and Home Location Register 52.

When the mobile entity 40 is used to make a normal telephone call, a traffic circuit for carrying digitised voice is set up through the relevant BSS 31 to the NSS 32 which is then responsible for routing the call to the target phone whether in the same PLMN or in another network such as PSTN (Public Switched Telephone Network) 56.

With respect to data transmission to/from the mobile entity 40, in the present example three different data-capable bearer services are depicted though other possibilities exist. A first data-capable bearer service is available in the form of a Circuit Switched Data (CSD) service; in this case a full traffic circuit is used for carrying data and the MSC 35 routes the circuit to an InterWorking Function IWF 54 the precise nature of which depends on what is connected to the other side of the IWF. Thus, IWF could be configured to provide direct access to the public Internet 60 (that is, provide functionality similar to an IAP—Internet Access Provider LAP). Alternatively, the IWF could simply be a modem connecting to PSTN 56; in this case, Internet access can be achieved by connection across the PSTN to a standard IAP.

A second, low bandwidth, data-capable bearer service is available through use of the Short Message Service that passes data carried in signalling channel slots to an SMS unit 53 which can be arranged to provide connectivity to the public Internet 60.

A third data-capable bearer service is provided in the form of GPRS (General Packet Radio Service which enables IP (or X.25) packet data to be passed from the data handling system of the mobile entity 40, via the data interface 44, radio subsystem 41 and relevant BSS 31, to a GPRS network 37 of the PLMN 30 (and vice versa). The GPRS network 37 includes a SGSN (Serving GPRS Support Node) 38 interfacing BSC 34 with the network 37, and a GGSN (Gateway GPRS Support Node) interfacing the network 37 with an external network (in this example, the public Internet 60). Full details of GPRS can be found in the ETSI (European Telecommunications Standards Institute) GSM 03.60 specification. Using GPRS, the mobile entity 40 can exchange packet data via the BSS 31 and GPRS network 37 with entities connected to the public Internet 60.

The data connection between the PLMN 30 and the Internet 60 will generally be through a gateway 55 providing functionality such as firewall and proxy functionality.

Different data-capable bearer services to those described above may be provided, the described services being simply examples of what is possible. Indeed, whilst the above description of the connectivity of a mobile entity to resources connected to the communications infrastructure, has been given with reference to a PLMN based on GSM technology, it will be appreciated that many other cellular radio technologies exist (for example, UTMS, CDMA etc.) and can typically provide equivalent functionality to that described for the GSM PLMN 30.

The mobile entity 40tself may take many different forms. For example, it could be two separate units such as a mobile phone (providing elements 42-44) and a mobile PC (providing the data-handling system 45), coupled by an appropriate link (wireline, infrared or even short range radio system such as Bluetooth). Alternatively, mobile entity 40 could be a single unit.

FIG. 6 depicts both a voice page server 4 connected to the public internet 60 and a voice-based service system 61 accessible via the normal telephone links.

The voice-based service system 61 is, for example, a call center and would typically be connected to the PSTN 56 and be accessible to mobile entity 40 via PLMN 30 and PSTN 56. The system 56 could also (or alternatively) be connected directly to the PLMN though this is unlikely. The voice-based service system 61 includes interactive voice response units implemented using voice pages interpreted by a voice browser 3A. Thus a user can user mobile entity 40 to talk to the service system 61 over the voice circuits of the telephone infrastructure; this arrangement corresponds to the situation illustrated in FIG. 4 where the voice browser is co-located with the voice page server.

If, as shown, the service system 61 is also connected to the public internet 60 and is enabled to receive VoIP (Voice over IP) telephone traffic, then provided the data handling subsystem 45 of the mobile entity 40 has VoIP functionality, the user could use a data capable bearer service of the PLMN 30 of sufficient bandwidth and QoS (quality of service) to establish a VoIP call, via PLMN 30, gateway 55, and internet 60, with the service system 61.

With regard to access to the voice services embodied in the voice pages held by voice page server 4 connected to the public internet 60, if the data-handling subsystem of the mobile entity is equipped with a voice browser 3E, then all that the mobile entity need do to use these services is to establish a data-capable bearer connection with the voice page server 4 via the PLMN 30, gateway 55 and internet 60, this connection then being used to carry the text based request response messages between the server 61 and mobile entity 4. This corresponds to the arrangement depicted in FIG. 3.

PSTN 56 can be provisioned with a voice browser 3B at internet gateway 57 access point. This enables the mobile entity to place a voice call to a number that routes the call to the voice browser and then has the latter connect to the voice page server 4 to retrieve particular voice pages. Voice browser then interprets these pages back to the mobile entity over the voice circuits of the telephone network. In a similar manner, PLMN 30 could also be provided with a voice browser at its internet gateway 55. Again, third party service providers could provide voice browser services 3D accessible over the public telephone network and connected to the internet to connect with server 4. All these arrangements are embodiments of the situation depicted in FIG. 5 where the voice browser is located in the communication network infrastructure between the user end system and voice page server.

It will be appreciated that whilst the foregoing description given with respect to FIG. 6 concerns the use of voice browsers in a cellular mobile network environment, voice browsers are equally applicable to other environments with mobile or static connectivity to the user.

Recently, much interest has been shown in “location-based”, “location-dependent”, or “location-aware” services for mobile users, these being services that take account of the current location of the user (or other mobile party). The most basic form of this service is the emergency location service whereby a user in trouble can press a panic button on their mobile phone to send an emergency request-for-assistance message with their location data appended. Another well known location-based service is the provision of traffic and route-guiding information to vehicle drivers based on their current position. The term “location-aware services” will be used herein to refer generically to these and similar services where a location dependency exists.

Location-aware services all require user location as an input parameter. A number of methods already exist for determining the location of a mobile user as represented by an associated mobile equipment. Example location-determining methods include use of GPS (Global Positioning System) satellite-based system, PLMN-based systems including both simple cell location and techniques involving timing advance measurements, and systems based on the known location of fixed beacon devices. Some of these methods result in the user knowing their location thereby enabling them to transmit it to a location-aware service they are interested in receiving, whilst other of the methods result in the user's location becoming known to a network entity from where it can be supplied directly to a location-aware service (generally only with the consent of the user concerned).

Most location-aware services vary either the content presented or the language of presentation in dependence on the user's location. Where a voice-based service is given location-dependency then this can also be in terms of content or language. Adapting the language of presentation to the user's location is not, in fact, entirely satisfactory since, of course, the user maybe travelling in a foreign country. It is more useful to set the language of presentation to that appropriate to the user's home location or, even better, to a language specified by the user.

The presentation of a voice-based service in the user's preferred language does, however, in part “sterilise” the service, particularly if the latter is of local origin.

It is an object of the present invention to provide a method and apparatus by which location can be taken into account without decreasing the usefulness of the service.

### SUMMARY OF THE INVENTION

According to a first aspect of the present invention, there is provided a content presentation method comprising the steps of:

(a) retrieving content to be presented;

(b) determining a presentation-controlling locality;

(c) presenting the content to a user with at least one attribute of the presentation, other than or additional to the content presented and language in which it is presented, being set in dependence on said presentation-controlling locality determined in step (b).

According to a second aspect of the present invention, there is provided a presentation method for content pages intended for use with a presentation style sheet, the method comprising the steps of:

(a) retrieving a content page to be presented;

(b) determining a presentation-controlling locality;

(c) retrieving a presentation style sheet in dependence on said presentation-controlling locality determined in step (b); and

(d) presenting the retrieved content page using the style sheet retrieved in step (c).

According to a third aspect of the present invention, there is provided a content presentation method comprising the steps of:

(a) retrieving content to be presented along with locality data indicating a locality associated with the content; and

(b) presenting the content to a user with at least one attribute of the presentation, other than or additional to the content presented and language in which it is presented, being set in dependence on said locality indicated by the locality data.

According to a fourth aspect of the present invention, there is provided a presentation method for content pages intended for use with a presentation style sheet, the method comprising the steps of:

(a) retrieving a content page to be presented along with style-sheet-set data identifying a set of style sheets;

(b) determining a presentation-controlling locality;

(c) retrieving a presentation style sheet, from said set of style sheets, in dependence on said presentation-controlling locality determined in step (b); and

(d) presenting the retrieved content page using the style sheet retrieved in step (c).

According to a fifth aspect of the present invention, there is provided a method of presenting content received from a content server to a user, wherein at least one attribute of the presentation, other than the content itself and language in which it is presented, where applicable, is set in dependence on the user's current locality.

According to a sixth aspect of the present invention, there is provided apparatus for presenting content pages intended for use with a presentation style sheet, the apparatus comprising:

means for retrieving a content page to be presented;

means for determining a presentation-controlling locality;

means for retrieving a presentation style sheet in dependence on said presentation-controlling locality; and

means for presenting the retrieved content page using the retrieved style sheet.

The invention finds particular application to the presentation of voice service pages through a voice browser where attributes of presentation such as accent used for voice output are set in dependence on the user's locality or a locality associated with the voice service page.

### BRIEF DESCRIPTION OF THE DRAWINGS

A method and apparatus embodying the invention will now be described, by way of non-limiting example, with reference to the accompanying diagrammatic drawings, in which:

FIG. 1 is a diagram illustrating the role of a voice browser;

FIG. 2 is a diagram showing the functional elements of a voice browser and their relationship to different types of voice markup tags;

FIG. 3 is a diagram showing a voice service implemented with voice browser functionality located in an end-user system;

FIG. 4 is a diagram showing a voice service implemented with voice browser functionality co-located with a voice page server;

FIG. 5 is a diagram showing a voice service implemented with voice browser functionality located in a network between the end-user system and voice page server;

FIG. 6 is a diagram of a mobile entity accessing voice services via various routes through a communications infrastructure including a PLMN, PSTN and public internet; and

FIG. 7 is a diagram of an embodiment of the invention involving a mobile phone for accessing a remote voice page server.

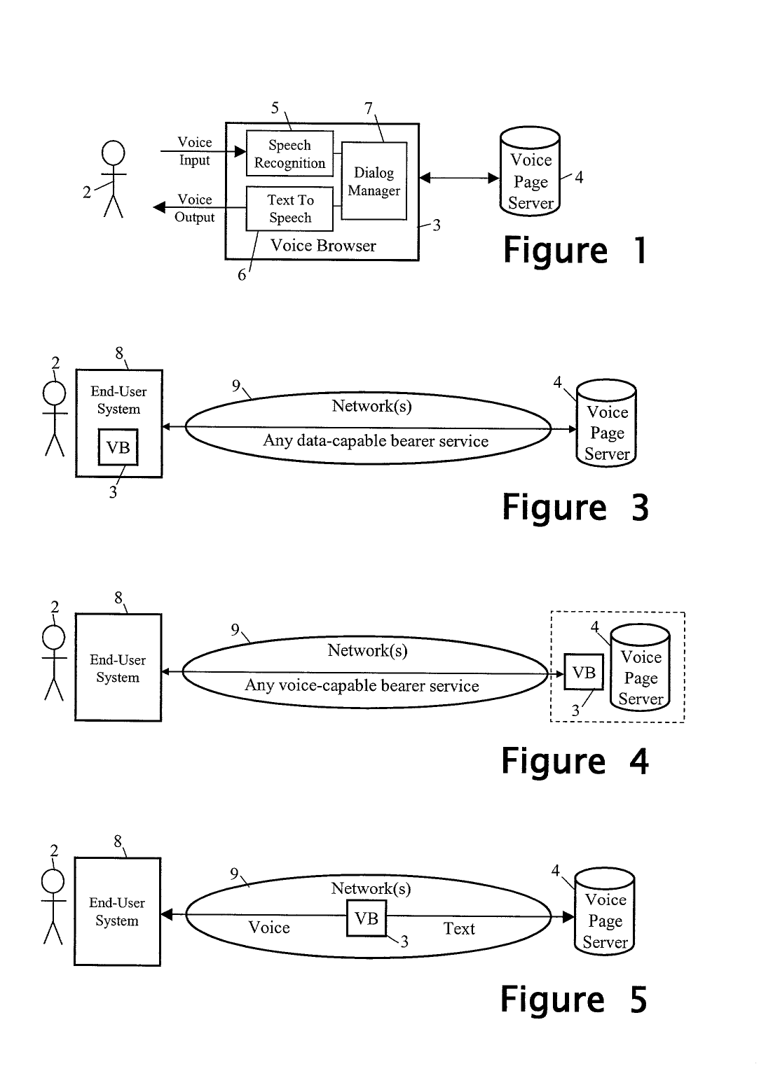

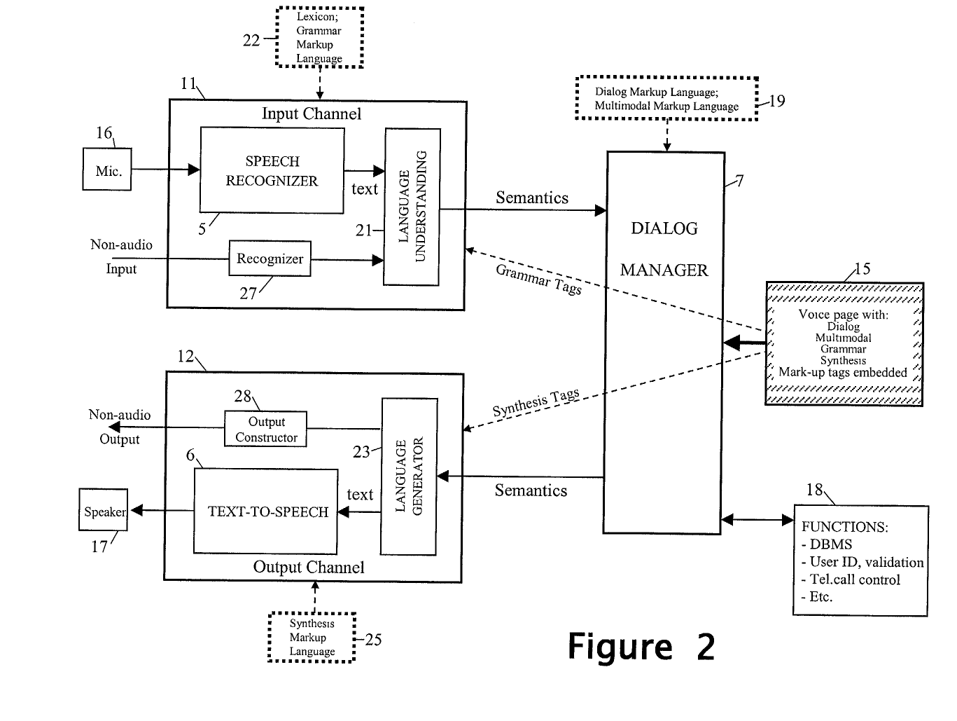

### BEST MODE OF CARRYING OUT THE INVENTION

In the following description, voice services are described based on voice page servers serving pages with embedded voice markup tags to voice browsers. Unless otherwise indicated, the foregoing description of voice browsers, and their possible locations and access methods is to be taken as applying also to the described embodiments of the invention. Furthermore, although the described embodiment uses a voice-browser based form of voice services are preferred, the present invention is not limited either to these forms of voice service system or, indeed, to voice service systems.

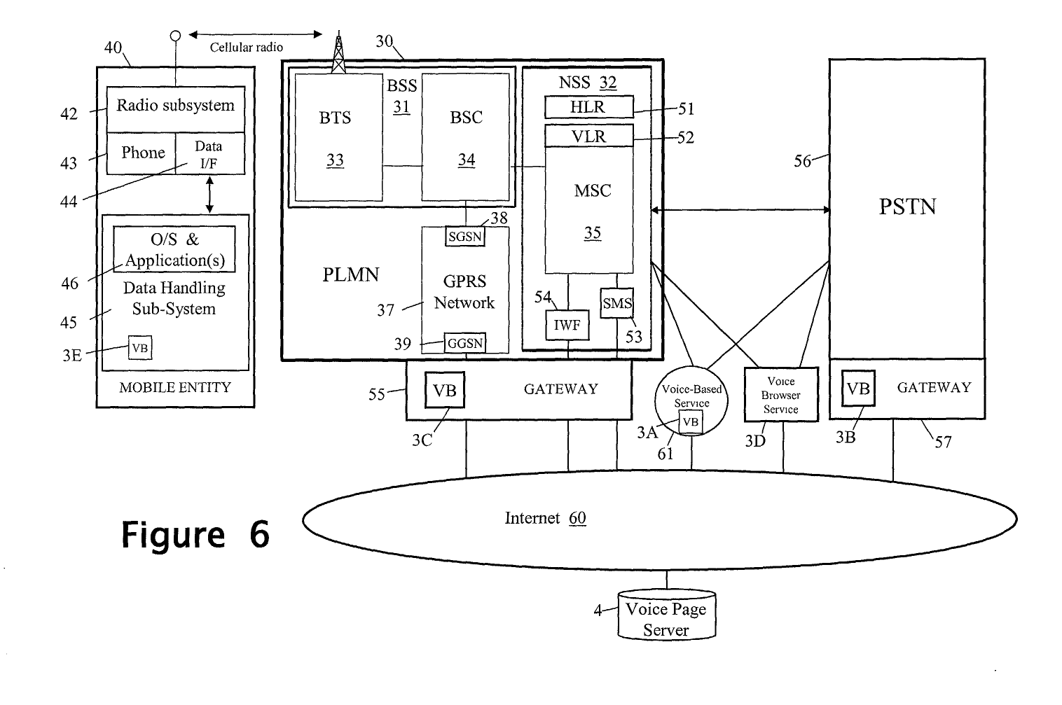

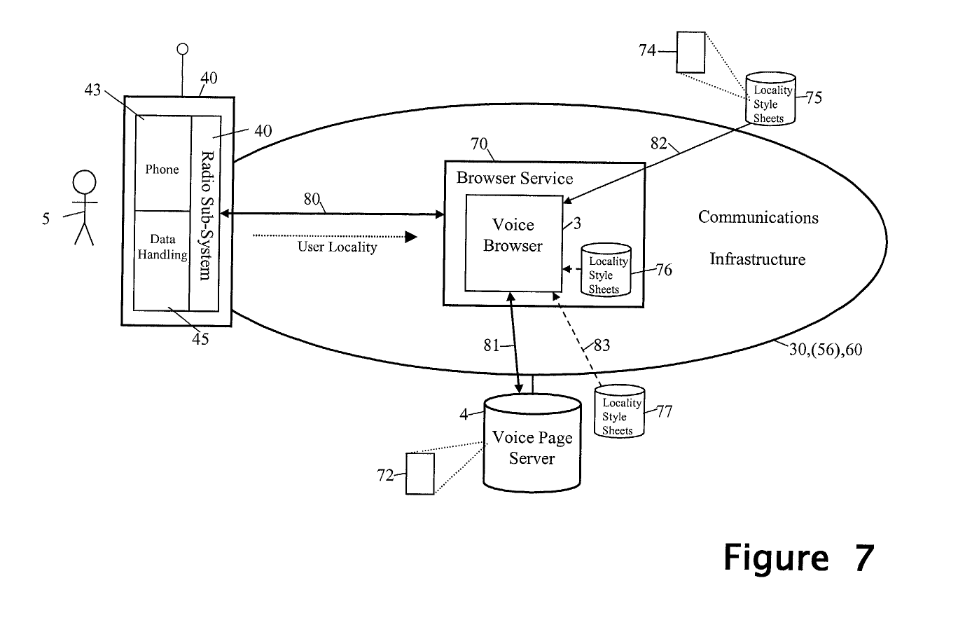

In the embodiment of the invention shown in FIG. 7, user 5 is using mobile device 40 to browse voice page server 4. The user is interfacing with the server 4 through a voice browser 3 that is hosted in a browser service system 70 connected to the communications infrastructure (here comprising PLMN 30, internet 60 and, potentially, PSTN 56 as in the FIG. 6 system); the service system 70 may be provided by a network operator or a third party. The server 4 thus exchanges content data with the browser 3 (see arrow 81) and the user exchanges voice data with the browser 3 (see arrow 80).

User 5 is a registered subscriber to the voice browser service of system 70 and can connect up to the voice browser service whenever the user wishes by connecting to the service system and supplying a username and password. Connection between the mobile device 40 and voice browser 3 can be either over a voice circuit or a data connection as already described in the introduction to the present specification.

In the present example, user 5 browses to voice page server 4 and retrieves a voice page 72 of interest. This page is retrieved to browser 3 which proceeds to interpret it in the language of writing or, potentially, in a different language specified by the user. The voice page includes a reference to a style sheet for setting attributes of the voice presentation, including accent. Normally, when a style sheet is used, it is precisely referenced and usually resides on the same server as the page referencing the style sheet. In the present case, however, the style sheet reference is to a set of style sheets residing on a third-party style-sheet server 75 with the actual style sheet to be used being intended to be chosen according to the user's current locality. This nature of the style sheet reference can be indicated by an appropriate attribute of the style sheet link.

The current locality of the user is provided to the browser 3 by the user either at initial log-on or when requested by the browser. The user's locality can be determined in any appropriate manner such as from cell ID where the user device 40 is a cell phone, by use of a GPS system associated with device 40, by use of a mobile-network-based method with the locality information being then supplied to the user, or even by user input either manually or by voice. Alternatively, the browser 3 can be authorised to retrieve the user's current location from a location server associated with PLMN 10.

The browser uses the user's locality information to retrieve from style sheet server 75 the style sheet 74 appropriate to the user's current locality (see arrow 82). The browser then uses the retrieved style sheet to set the accent of voice presentation and any other attributes specified in the style sheet (such as background sounds).

Instead of relying on the set of third-party style sheets held on server 75, the server 4 can reference its own associated set of locality-dependent style sheets here shown as held on server 77, the browser retrieving the appropriate style sheet as needed, this time from server 77 (see arrow 83).

The user or browser service provider can alternatively provide their own set of style sheets (see store 76 of service system 70) which the browser 3 substitutes for those intended to be used by the voice page server. However, there is no guarantee that the defined styles will match with those called for by the served page. The browser can, nevertheless, analyse the style sheet proposed by the served page and substitute equivalent parts of its own style sheets.

With the described arrangement, the user is presented with content in a voice carrying the local accent, thereby adding local colour to the content presented.

Many variants are, of course, possible to the arrangement described above with reference to FIG. 7. For example, the user's locality could be passed to the server 4 to enable the latter to specify the required locality-dependent style sheet. Alternatively, the fetching of the correct style sheet could be left to the mobile device 40 (which has the advantage that the user's locality information is not passed to the browser 3 or server 4). Of course, the user's device is not limited to being a mobile device and could, for example, be a desktop computer.

Attributes of presentation other than those specified in a style sheet can be made user-locality dependent.

Controlling the presentation style of a content page in dependence on the user's locality is not limited to voice browser based systems and can be applied to any type of browser. For example, a web page retrieved to a graphical browser can have its visual presentation style set according to the user's location; thus, the background image used for the page can be automatically selected according to the user's currently locality.

Furthermore, instead of the user's locality being used to set presentation features, a different locality associated with the served content page could be used, such as a locality associated with the originator of the document or the document provider (publisher or person controlling the server concerned). In this case, locality data is passed along with the served content page (preferably included in it but potentially otherwise associated with the page) enabling the recipient to retrieve an appropriate style sheet. The recipient may, of course, decide to use a different locality to that included with the content page to determine presentation style.

Whilst the foregoing description has been in terms of served content pages, it will be appreciated that the setting of presentation style in dependence on locality can be applied to any content capable of having presentation features finally specified at the time of presentation; such content can include streaming media and locally-stored documents

1. A content presentation method comprising the steps of:
(a) retrieving content to be presented;
(b) determining a presentation-controlling locality;
(c) presenting the content to a user with at least one attribute of the presentation, other than or additional to the content presented and language in which it is presented, being set in dependence on said presentation-controlling locality determined in step (b).

2. A method according to claim 1, wherein said presentation-controlling locality is the user's current locality.

3. A method according to claim 1, wherein said presentation-controlling locality is a locality identified in locality data included in, or otherwise associated with, the retrieved content.

4. A method according to claim 1, wherein the content is provided in the form of content pages served over a network from a content server.

5. A method according to claim 1, wherein the content is presented at least partially in a visual manner, the said at least one attribute being a visual attribute.

6. A method according to claim 1, wherein the content is presented at least partially by sound, the said at least one attribute being an audio attribute.

7. A method according to claim 1, wherein the content is presented by voice with the accent of the voice being set to reflect a regional accent appropriate to the said presentation-controlling locality.

8. A method according to claim 1, wherein the content is provided in the form of a content page intended for use with a style sheet, step (c) involving selecting a style sheet according to said presentation-controlling locality and applying it to said content.

9. A method according to claim 8, wherein said presentation-controlling locality is the user's current locality.

10. A method according to claim 8, wherein said presentation-controlling locality is a locality identified in locality data included in, or otherwise associated with, the content page.

11. A method according to claim 8, wherein the style sheet is selected from a set of locality-dependent style sheets, this set being specified by the user.

12. A method according to claim 8, wherein the style sheet is selected from a set of locality-dependent style sheets, this set being specified by the content server by a style-sheet-set reference associated with the content.

13. A method according to claim 8, wherein the content is presented by voice with the accent of the voice being set to reflect a regional accent appropriate to the said presentation-controlling locality.

14. A method according to claim 4, wherein the said presentation-controlling locality is sent to the content server which uses this information to set the said at least one attribute before sending the content to the user.

15. A method according to claim 1, wherein steps (a) to (c) are effected by equipment physically associated with the user.

16. A method according to claim 1, wherein the content is provided in the form of content pages intended for use with a style sheet, the style sheet appropriate to the said presentation-controlling locality being fetched from a remote server by user equipment physically associated with the user.

17. A presentation method for content pages intended for use with a presentation style sheet, the method comprising the steps of:
(a) retrieving a content page to be presented;
(b) determining a presentation-controlling locality;
(c) retrieving a presentation style sheet in dependence on said presentation-controlling locality determined in step (b); and
(d) presenting the retrieved content page using the style sheet retrieved in step (c).

18. A method according to claim 17, wherein the content page is presented at least partially by sound, the retrieved style sheet being an audio style sheet.

19. A method according to claim 17, wherein said presentation-controlling locality is the user's current locality.

20. A method according to claim 17, wherein said presentation-controlling locality is a locality identified in locality data included in, or otherwise associated with, the content page.

21. A content presentation method comprising the steps of:
(a) retrieving content to be presented along with locality data indicating a locality associated with the content; and
(b) presenting the content to a user with at least one attribute of the presentation, other than or additional to the content presented and language in which it is presented, being set in dependence on said locality indicated by the locality data.

22. A method according to claim 21, wherein the content is provided in the form of content pages intended for use with a style sheet, step (b) involving selecting a style sheet according to said locality and applying it to said content.

23. A presentation method for content pages intended for use with a presentation style sheet, the method comprising the steps of:
(a) retrieving a content page to be presented along with style-sheet-set data identifying a set of style sheets;
(b) determining a presentation-controlling locality;
(c) retrieving a presentation style sheet, from said set of style sheets, in dependence on said presentation-controlling locality determined in step (b); and
(d) presenting the retrieved content page using the style sheet retrieved in step (c).

24. A method according to claim 23, wherein the content page is presented at least partially by sound, the retrieved style sheet being an audio style sheet.

25. A method according to claim 23, wherein said presentation-controlling locality is the user's current locality.

26. A method according to claim 23, wherein said presentation-controlling locality is a locality identified in locality data included in, or otherwise associated with, the content page.

27. A method of presenting content received from a content server to a user, wherein at least one attribute of the presentation, other than the content itself and language in which it is presented, where applicable, is set in dependence on the user's current locality.

28. Apparatus for presenting content pages intended for use with a presentation style sheet, the apparatus comprising:
means for retrieving a content page to be presented;
means for determining a presentation-controlling locality;
means for retrieving a presentation style sheet in dependence on said presentation-controlling locality; and
means for presenting the retrieved content page using the retrieved style sheet.

29. Apparatus according to claim 28 wherein the said means for presenting the retrieved content page operative to present the content page at least partially by sound, the retrieved style sheet being an audio style sheet.

30. Apparatus according to claim 28, wherein said presentation-controlling locality is the user's current locality, the said means for determining the presentation-controlling locality being an arrangement for determining the location of the apparatus.

31. Apparatus according to claim 28, wherein said presentation-controlling locality is a locality identified in locality data included in, or otherwise associated with, the content page, the said means for determining the presentation-controlling locality being means operative to receive the locality data along with the content page.
